(19) United States
(12) Patent Application Publication
(10) Pub. No.: US 2026/0116133 A1
(43) Pub. Date: Apr. 30, 2026

(54) COUPLING DEVICE

(71) Applicant: Armin Klein, Wiehl (DE)

(72) Inventor: Armin Klein, Wiehl (DE)

(73) Assignee: ACPS Automotive GmbH, Ingersheim (DE)

(21) Appl. No.: 19/366,859

(22) Filed: Oct. 23, 2025

(30) Foreign Application Priority Data
Oct. 30, 2024 (DE) 102024131695.0

(51) Int. Cl. B60D 1/52; B60D 1/24; B60D 1/54; G01V 3/08

(52) U.S. Cl. CPC B60D 1/52; B60D 1/246; B60D 1/54; G01V 3/08

(57) ABSTRACT

In order to improve a coupling device, comprising a carrier unit that is mountable at the rear of a vehicle body, a holding unit that is held on the carrier unit and comprises a carrier element to which a mounting element is detachably connectable, wherein the mounting element is configured either for attaching a trailer or for carrying a load carrier, such that the holding unit is provided with a sensor for detecting the mounting element in its position held on the carrier element, it is proposed that in this way the sensor can monitor whether the mounting element is in its position held on the carrier element or not, with the result that there is a considerable advantage in terms of the operational reliability of the coupling device and in this way it can be unambiguously established whether the mounting element is arranged on the carrier element or not.

### CROSS-REFERENCE TO RELATED PATENT APPLICATION

The present disclosure relates to the subject matter disclosed in German application number 10 2024 131 695.0 of 30 Oct. 2024, which is incorporated herein by reference in its entirety and for all purposes.

### BACKGROUND OF THE INVENTION

The invention relates to a coupling device, comprising a carrier unit that is mountable at the rear of a vehicle body, a holding unit that is held on the carrier unit and comprises a carrier element to which a mounting element is detachably connectable, wherein the mounting element is configured either for attaching a trailer or for carrying a load carrier.

Coupling devices of this kind are known from the prior art.

However, these have the problem of operational reliability of the coupling device.

In order to improve the operational reliability of the coupling device, according to the invention the holding unit is provided with a sensor for detecting the mounting element in its position held on the carrier element.

### SUMMARY OF THE INVENTION

The advantage of this solution can be seen in the fact that it enables the sensor to monitor whether the mounting element is in its position held on the carrier element or not, with the result that there is a considerable advantage in terms of the operational reliability of the coupling device and in this way it can be unambiguously established whether the mounting element is arranged on the carrier element or not.

Here, an advantageous solution provides for the sensor to be arranged such that, in the position in which the mounting element is connected to the carrier element, it detects the presence of a predefined region of the mounting element.

The advantage of this solution can be seen in the fact that it provides the possibility of identifying whether the mounting element is in its position arranged on the carrier element or not.

Advantageously, in this context it is provided for the sensor to detect a region of the mounting element facing away from the road surface.

The advantage of this solution can be seen in the fact that there is no impairment of detection of the mounting element by dirt that is thrown up from the road surface or other materials that impair detection of the mounting element.

Favorably, the sensor is arranged in a region of the holding unit facing away from the road surface.

This advantageously enables the sensor to be protected from damage and also dirt from materials thrown up from the road surface.

In this context, the sensor could fundamentally be arranged at many points on the holding unit.

A particularly simple solution provides for the sensor to be arranged on the carrier element, since as a result the sensor can be arranged as close as possible to the mounting element that is connected to the carrier element in order to detect it.

In this case, preferably the sensor is likewise arranged on a side of the carrier element facing away from the road surface.

More detailed statements have not yet specifically been made as regards the form taken by the carrier element.

Thus, an advantageous solution provides for the carrier element to comprise a receiving body into which, for the purpose of making a connection with the mounting element, an insertion portion of the mounting element is insertable.

In this case, it is preferably provided for the sensor to detect, as the predefined region of the mounting element, the insertion portion that is inserted into the receiving body of the carrier element.

So that the insertion portion can be detected with precision, it would for example be conceivable to arrange the sensor such that it detects the insertion portion from an opposite side to an insertion opening of the carrier element.

However, a favorable solution provides for the sensor to detect the insertion portion through an opening in the carrier element and thus to act through the opening in detecting that the insertion portion is in the carrier element.

Furthermore, the coupling device is preferably provided with a fixing device which, in relation to the carrier element, detachably fixes the mounting element in its position held on the carrier element, since a loose connection between the mounting element and the carrier element, for example by inserting the insertion portion into the carrier element, still does not provide sufficient security against the connection becoming detached.

For this reason, preferably a sensor is provided for detecting the fixing device in its position in which the mounting element is fixed to the carrier element.

A fixing device of this kind may be configured in different ways.

For example, a fixing device of this kind may be a latching device or any type of locking device.

A particularly simple configuration of the fixing device provides for the fixing device to comprise a fixing element that is transferable from a non-blocking position to a blocking position, and for the sensor to detect the blocking position of the fixing element.

In particular, the fixing device may be configured in a simple and advantageous manner if the fixing element fixes the insertion portion of the mounting element in relation to the carrier element.

In that case, the fixing element is active between the insertion portion and the carrier element, in particular the receiving body of the carrier element.

In the simplest case, the fixing element takes the form of a fixing bolt which, in its blocking position, passes through the receiving body and the insertion portion and thus fixes them in relation to one another.

This solution is on the one hand known, and on the other its functioning is simple for a user to manage and to identify in its blocking position.

Further, the presence of a fixing bolt of this kind is likewise easily determinable by a sensor for the purpose of detecting the fixing device.

More detailed statements have not yet been made as regards the form taken by the sensor.

Thus, an advantageous solution provides for the sensor to be a magnetic field sensor.

It is particularly advantageous here if the sensor detects deformation of a magnetic field using a magnetic field detector.

As an alternative to this, however, it is likewise conceivable for the sensor to be an ultrasound sensor which detects the presence of the insertion portion in the carrier element using ultrasound.

More detailed statements have not yet been made, in the context of the form taken by the carrier holder, as to the form this is to take.

An advantageous solution provides for the carrier element to be pivotal in relation to the holding unit about at least one pivot axis, between a working position and a rest position, by way of a pivotal bearing unit that forms the carrier holder.

This solution has the advantage that it provides the possibility of transferring the carrier element from a working position to a rest position in which it is preferably completely covered by the bumper unit of the vehicle body and is thus substantially invisible on the vehicle in the rest position.

Preferably in this context, the pivot axis is arranged such that it extends transversely to a longitudinal center plane of the coupling device.

As an alternative to this, however, it is also conceivable for the pivot axis to extend approximately parallel to the longitudinal center plane of the coupling device.

In this context, the pivotal bearing unit may be manually movable between the working position and the rest position.

In the case of manually pivoting between the working position and the rest position, either a manually actuable locking device or an electrically actuable locking device is provided for fixing the carrier element in the working position and the rest position.

In the case of an electrically actuable locking device, this is controllable by a locking controller.

A further advantageous solution provides for the pivotal bearing unit to be provided with an electric drive, by which a locking device is also driven.

An electric drive of this kind is in that case likewise configured such that it is controllable by a pivot controller.

In order to ensure reliable operation of the coupling device, it is preferably provided for the coupling device to be coupled to a monitoring circuit which uses the sensor to detect the presence or non-presence of the mounting element in its position connected to the carrier element, and generates a presence signal or a non-presence signal.

Furthermore, it is preferably provided for the monitoring circuit to use a sensor to detect the presence of a blocking position or non-blocking position of the fixing device for the mounting element, and to generate a blocking position signal or a non-blocking position signal.

A particularly advantageous solution provides for the monitoring circuit, in the event that the presence signal is identified and the blocking position signal is detected, to activate a positive status notification for operation of the coupling device and, in the event that the non-presence signal and/or a non-blocking signal is identified, to activate a negative status notification.

Furthermore, an advantageous solution provides for the monitoring circuit to co-operate with a blocking unit for the pivot controller of the electric drive or for the locking controller in order, if there is a presence signal, to block the pivot controller for the electric drive or the locking controller for the electrically actuable locking device in order to prevent unlocking of the locking device and thus pivoting of the carrier element from the working position into the rest position, and only if there is a non-presence signal to clear the pivot controller or the locking controller for performance of the pivotal movement between the working position and the rest position.

Thus, the description above of solutions according to the invention comprises in particular the different combinations of features that are defined by the sequentially numbered embodiments below:
1. A coupling device, comprising a carrier unit (22) that is mountable at the rear of a vehicle body (12), a holding unit (30) that is held on the carrier unit (22) and comprises a carrier element (40) to which a mounting element (50) is detachably connectable, wherein the mounting element (50) is configured either for attaching a trailer or for carrying a load carrier, wherein the holding unit (30) is provided with a sensor (112) for detecting the mounting element (50) in its position held on the carrier element (40).
2. The coupling device according to embodiment 1, wherein the sensor (112) is arranged such that, in the position in which the mounting element (50) is connected to the carrier element (40), it detects the presence of a predefined region (36) of the mounting element (50).
3. The coupling device according to embodiment 2, wherein the sensor (112) detects a region of the mounting element (50) facing away from the road surface (54).
4. The coupling device according to one of the preceding embodiments, wherein the sensor (112) is arranged in a region of the holding unit (50) facing away from the road surface (54).
5. The coupling device according to one of the preceding embodiments, wherein the sensor (112) is arranged on the carrier element (40).
6. The coupling device according to embodiment 5, wherein the sensor (112) is arranged on a side of the carrier element (40) facing away from the road surface (54).
7. The coupling device according to one of the preceding embodiments, wherein the carrier element (40) comprises a receiving body (32) into which, for the purpose of making a connection with the mounting element (50), an insertion portion (36) of the mounting element (50) is insertable.
8. The coupling device according to one of the preceding embodiments, wherein the sensor (112) detects, as the predefined region of the mounting element (50), the insertion portion (36) that is inserted into the receiving body (32) of the carrier element (40).
9. The coupling device according to one of the preceding embodiments, wherein the sensor (112) detects the insertion portion (36) through an opening (140) in the carrier element (40).
10. The coupling device according to one of the preceding embodiments, wherein a fixing device (90) is provided which, in relation to the carrier element (40), detachably fixes the mounting element (50) in its position held on the carrier element (40).
11. The coupling device according to embodiment 10, wherein a sensor (122) is provided for detecting the fixing device (90) in its position in which the mounting element (50) is fixed to the carrier element (40).
12. The coupling device according to embodiment 11, wherein the fixing device (90) comprises a fixing element (88), and wherein the sensor (122) detects a blocking position of the fixing element (88).
13. The coupling device according to embodiment 12, wherein the fixing element (88) fixes the insertion portion (36) of the mounting element (50) in relation to the carrier element (40).
14. The coupling device according to embodiment 13, wherein the fixing element (88) is active between the insertion portion (36) and the receiving body (32) of the carrier element (40).
15. The coupling device according to embodiment 14, wherein the fixing element takes the form of a fixing bolt (88) which, in its blocking position, passes through the receiving body (32) and the insertion portion (36) and thus fixes them in relation to one another.
16. The coupling device according to one of the preceding embodiments, wherein the sensor (112) is a magnetic field sensor.
17. The coupling device according to embodiment 16, wherein the sensor (112) detects deformation of a magnetic field (116) using a magnetic field detector (118).
18. The coupling device according to one of embodiments 1 to 15, wherein the sensor (112) is an ultrasound sensor.
19. The coupling device according to one of the preceding embodiments, wherein the carrier element (40) is pivotal in relation to the holding unit (30) about at least one pivot axis (164), between a working position (A) and a rest position (R), by way of a pivotal bearing unit (162) that forms the carrier holder (28).
20. The coupling device according to embodiment 19, wherein the pivot axis (164) extends transversely to a longitudinal center plane (166) of the coupling device (20).
21. The coupling device according to embodiment 19, wherein the pivot axis (166′) extends approximately parallel to the longitudinal center plane (166) of the coupling device (20).
22. The coupling device according to one of embodiments 19 to 21, wherein the pivotal bearing unit (162) is provided with an electrically actuable locking device (178).
23. The coupling device according to one of embodiments 19 to 21, wherein the pivotal bearing unit (162) is provided with an electric drive (168).
24. The coupling device according to one of embodiments 18 to 23, wherein the electric drive (168) is controllable by a pivot controller (172).
25. The coupling device according to one of the preceding embodiments, wherein the coupling device (20) is coupled to a monitoring circuit (150) which uses the sensor (112) to detect the presence or non-presence of the mounting element (50) in its position connected to the carrier element (40), and generates a presence signal (PS) or a non-presence signal (NPS).
26. The coupling device according to one of the preceding embodiments, wherein the monitoring circuit (150) uses a sensor (122) to detect the presence of a blocking position or non-blocking position of the fixing device (90) for the mounting element (50), and generates a blocking position signal (BS) or a non-blocking position signal (NBS).
27. The coupling device according to embodiment 26, wherein the monitoring circuit (150), in the event that the presence signal (PS) is identified and the blocking position signal (BS) is detected, activates a positive status notification (156) for operation of the coupling device and, in the event that the non-presence signal (NPS) and/or a non-blocking signal (NBS) is identified, activates a negative status notification (154).
28. The coupling device according to one of embodiments 25 to 27, wherein the monitoring circuit (150) co-operates with a blocking unit (158) for the pivot controller (172) of the electric drive (168) and, if there is a presence signal (PS), blocks the pivot controller (172) for the electric drive (168) from pivoting the carrier element (40) from the working position (A) into the rest position (R), and only if there is a non-presence signal clears the pivot controller (172) for performance of the pivotal movement between the working position (A) and the rest position (R).
29. The coupling device according to one of embodiments 24 to 27, wherein the monitoring circuit (150) co-operates with a blocking unit (182) for the locking controller (184) of the locking device (178) and, if there is a presence signal (PS), blocks the locking controller (184) for the electrically actuable locking device (178) in order to prevent unlocking of the locking device (178) and thus pivoting of the carrier element (40) from the working position (A) into the rest position (R), and only if there is a non-presence signal (NPS) clears the locking controller (184) for clearance of the pivotal movement between the working position (A) and the rest position (R).

Further features of the invention form the subject matter of the description below and of some exemplary embodiments represented in the drawing.

### BRIEF DESCRIPTION OF THE DRAWINGS

FIG. 1 shows a side view of a motor vehicle with a coupling device according to the invention;

FIG. 2 is a perspective illustration of the coupling device according to the invention with a mounting element, before this last is inserted into a carrier element;

FIG. 3 shows a side view of the coupling device in the direction of the arrow S in FIG. 2, with the mounting element inserted into the carrier element, but not showing a carrier holder of the holding unit;

FIG. 4 shows a plan view in the direction of the arrow D in FIG. 4, with the mounting element inserted into the carrier element, but not showing the carrier holder;

FIG. 5 shows a section along the line 5-5 in FIG. 4;

FIG. 6 is a perspective illustration of the carrier element with the mounting element inserted, in the blocking position;

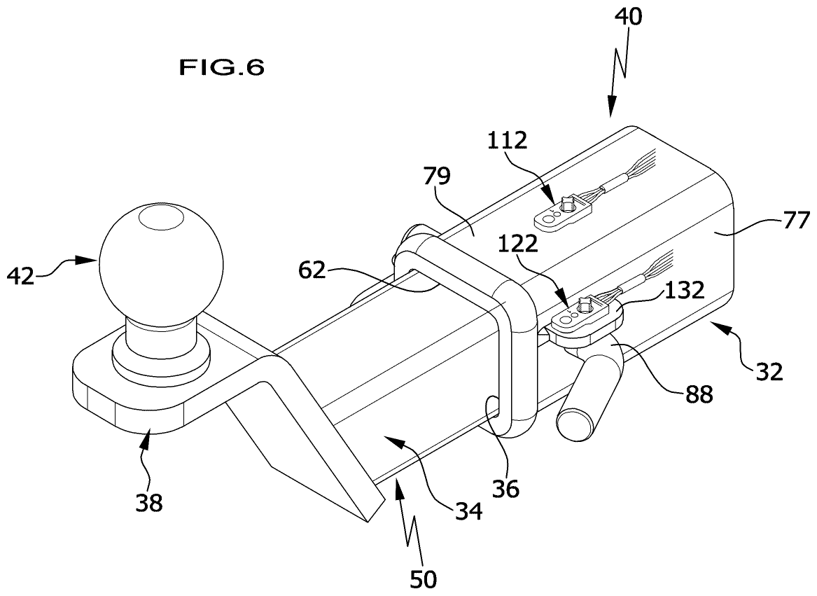

FIG. 7 is a schematic illustration of a monitoring circuit;

FIG. 8 is a perspective illustration of a second exemplary embodiment of a trailer coupling according to the invention in the working position, in which the carrier holder takes the form of a pivotal bearing unit;

FIG. 9 is a perspective illustration of the second exemplary embodiment of the trailer coupling according to the invention in the rest position;

FIG. 10 is a schematic illustration of a variant of the monitoring circuit of the pivotal bearing unit of the first exemplary embodiment, in the case of a driven pivotal bearing unit;

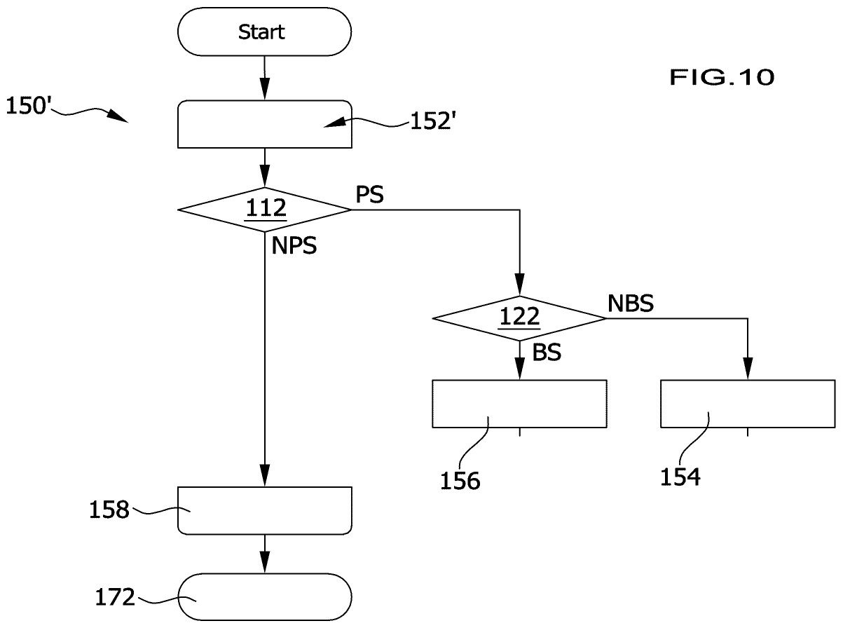

FIG. 11 is a perspective illustration of a third exemplary embodiment of a trailer coupling according to the invention in the working position, in which the carrier holder takes the form of a pivotal bearing unit;

FIG. 12 is a perspective illustration of the third exemplary embodiment of the trailer coupling according to the invention in the rest position;

FIG. 13 is a schematic illustration of a variant of the monitoring circuit of the pivotal bearing unit of the first exemplary embodiment, in the case of a pivotal bearing unit with an electrical locking device;

FIG. 14 is a perspective illustration of a fourth exemplary embodiment of a coupling device according to the invention in plan view, viewed in the direction of travel, in the working position;

FIG. 15 is an illustration similar to FIG. 4 in the rest position;

FIG. 16 is a perspective illustration of a fifth exemplary embodiment of a trailer coupling according to the invention in the working position; and

FIG. 17 is a perspective illustration of the fifth exemplary embodiment of the trailer coupling according to the invention in the rest position.

### DETAILED DESCRIPTION OF THE INVENTION

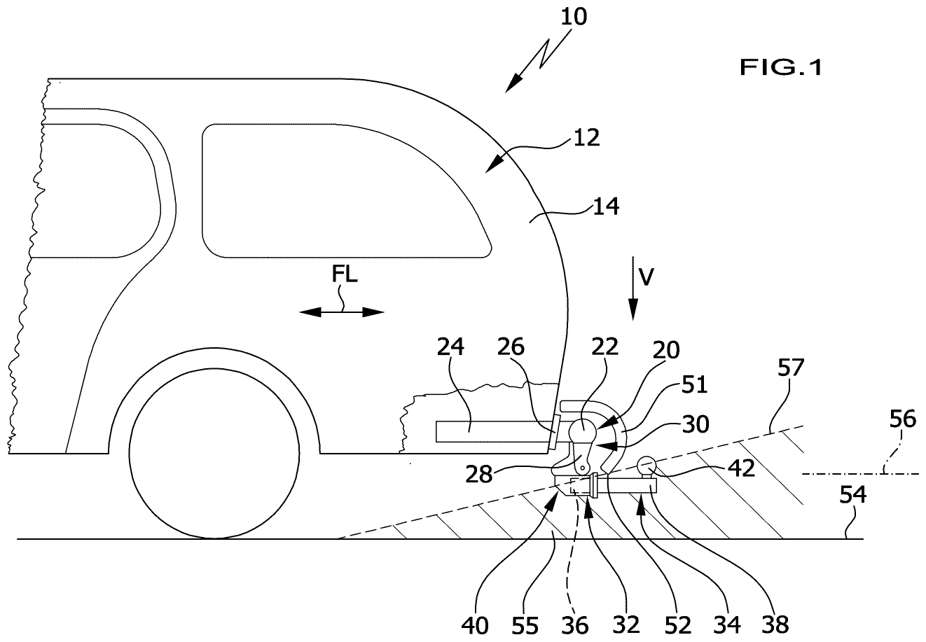

A motor vehicle, which in FIG. 1 is designated 10 as a whole, comprises a vehicle body 12 on which a coupling device 20 according to the invention is mounted on a rear region 14.

The coupling device 20 comprises, as the carrier unit, for example a transverse carrier 22 that extends transversely to a vehicle longitudinal direction FL and is connected, for example by side carriers 24 that extend approximately parallel to the vehicle longitudinal direction FL, at body portions that likewise extend in the vehicle longitudinal direction FL, and/or by holding flanges 26, to the rear region 14 of the vehicle body 12.

Provided on the transverse carrier 22 is a holding unit that is designated 30 as a whole and comprises a carrier holder 28 and a carrier element, which is designated 40 as a whole and is connected to the transverse carrier 22 by the carrier holder 28 and to which there is detachably connectable a mounting element that is designated 50 as a whole and enables a connection to a trailer or a load carrier.

For example, the carrier element 40 comprises a receiving body 32, and when this receiving body 32 is in a working position A there is insertable into it as the mounting element 50 for example a coupling element which is designated 34 as a whole and has an insertion portion 36 that forms a first end of the coupling element 34, while a second end 38 of the coupling element 34, which is opposed to the insertion portion 36 and in the inserted condition projects rearward beyond the receiving body 32, away from the vehicle body 12 and beyond the receiving body 32, carries for example a coupling ball 42 or a load carrier unit, such as bicycles or baggage, which is connected to the coupling ball 42 or is directly connected to the end 38.

As an alternative, however, the mounting element 50 may take the form of a load carrier or bicycle carrier that is likewise provided with an insertion portion 36.

In the case of the motor vehicle according to the invention, the transverse carrier 22, end portions of the side carriers 24 that for example hold the transverse carrier 22, and/or holding flanges 26 that hold the transverse carrier 22 are preferably covered by a bumper unit 51 of the vehicle body 12, which reaches over the transverse carrier 22 on an upper side facing away from a road surface 54 and a rear side facing away from the rear region 14 of the vehicle body 12 and likewise reaches over the holding unit 30 on its upper side facing away from the road surface 54 and its side facing away from the rear region 14, with the result that, when the vehicle body 12 is viewed from behind, in its working position only the receiving body 32 is located in a visible region 55, below a lower edge 52 of the bumper unit 51 and below a plane 56, running parallel to the road surface 54 and touching the lower edge.

In this context, the visible region 55 is for example limited by a line of sight 57 which is inclined at 15° to the road surface 54 and which touches the lower edge 52 of the bumper unit 51 and lies below these, as illustrated in FIG. 1.

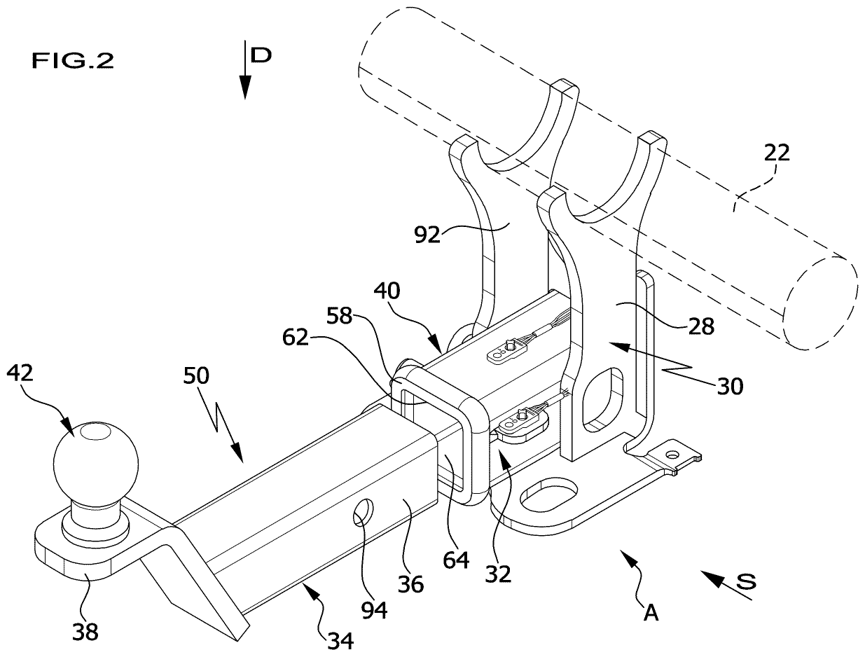

Thus, in the working position, as illustrated in particular in FIG. 2, an insertion opening 62 which lies on an end side 58 of the receiving body 32 is visible.

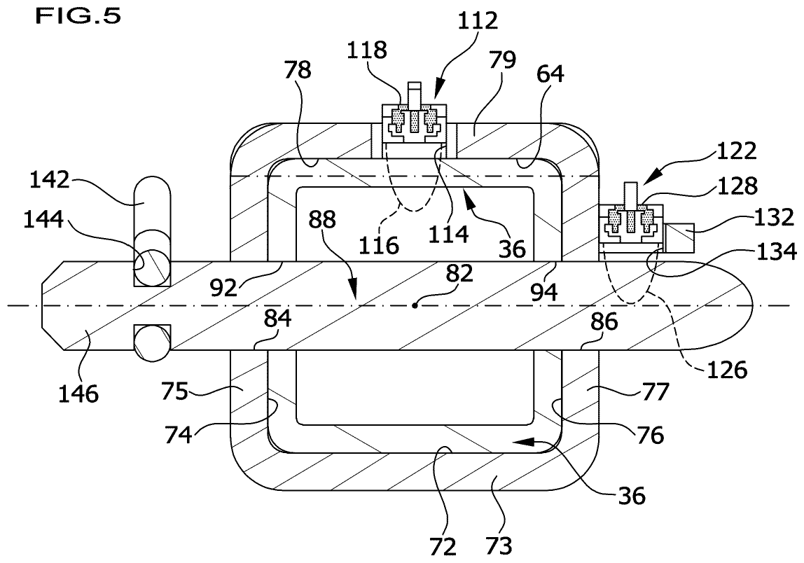

As illustrated in FIG. 2 to FIG. 5, from the insertion opening 62 a receptacle 64 extends into the receiving body 32, wherein the receptacle 64 is adapted, for example for the purpose of receiving the insertion portion 36, to a rectangular or square cross-sectional shape of the insertion portion 36, and forms by way of the receiving body 32, on a side facing the road surface 54, a support face 72 and, on both sides running transversely to the road surface 54, support faces 74, 76 and, on a side facing away from the road surface 54, a support face 78, as illustrated in FIGS. 2 and 5.

Preferably, as illustrated in FIGS. 1 to 5, in the working position A of the receptacle 64 a center axis 82 thereof runs approximately parallel to the vehicle longitudinal direction FL and likewise approximately horizontally in the case of a motor vehicle 10 that is standing on a horizontal road surface 54.

Here, the terms “approximately parallel” and “approximately horizontal” are to be understood to have a deviation of up to 20° from an exact parallel or exact horizontal.

For the purpose of forming the support faces 72, 74, 76, 78, the receiving body 32 comprises in particular a lower transverse wall 73 which faces the road surface 54 in the working position A, and transversely thereto side walls 75 and 77 which extend away from the road surface 54 in the working position A, and a transverse wall 79 which faces away from the road surface 54 and forms the support face 78, wherein in particular the transverse walls 73, 79 and the side walls 75 and 77 respectively run approximately parallel relative to the center axis 82.

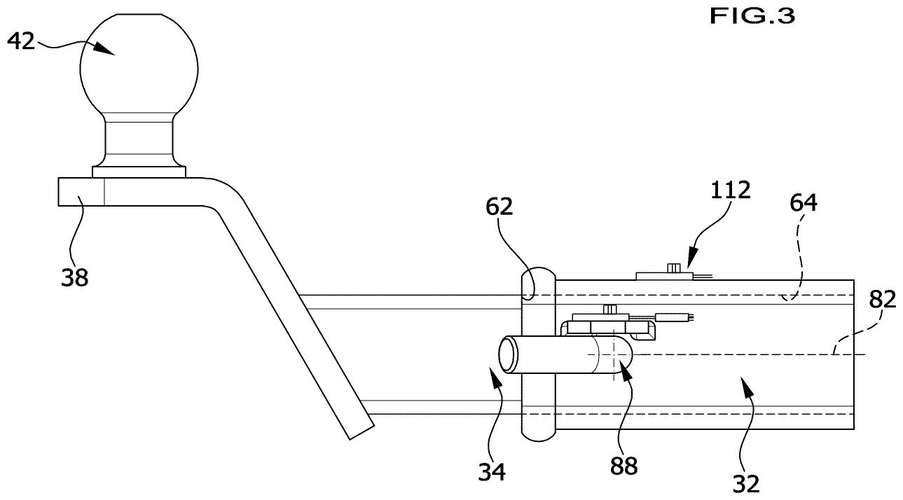

To form a fixing device 90, at a spacing from the insertion opening 62 the receiving body 32 is provided in the region of the mutually opposing side walls 75 and 77 with mutually opposing apertures 84, 86 through which a fixing bolt 88, illustrated in FIG. 3, is pushable in order to pass through the insertion portion 36 of the coupling element 34 that is inserted into the receptacle 66, likewise at apertures 92, 94, and thus to fix it in relation to the receiving body 32, such that the latter is fixable in the receptacle 64 in a manner preventing movements in the direction parallel to the center axis 82 thereof and also in a manner preventing rotation about the center axis 82.

Moreover, the insertion portion 36 is likewise fixed in the receptacle 64 in a manner preventing rotary movement about the center axis 82 by the fact that the receptacle 64 has an approximately rectangular or square cross-sectional shape that is adapted to the insertion portion 36, and hence is also fixed in a manner preventing movements transverse to the center axis 82, wherein support faces 72, 74, 76, 78 that delimit the receptacle 64 provide support.

Thus, the insertion portion 36 of the coupling element 34 is guided with little play both by the side walls 75 and 77 and also by the transverse walls 73, 79 when the receiving body 32 is in the working position.

Preferably, the receiving body 32 takes a form such that the receptacle 64 extends entirely through it from the insertion opening 62, for example as far as an opening on the rear side, opposite the insertion opening 62.

Thus, as is discernible from FIGS. 1 and 2, the receiving body 32 lies at a spacing from the road surface 54 such that it is close to but below the plane 56 which runs through the lower edge 52 of the bumper unit 51 and extends approximately parallel to the road surface 54.

Thus, the coupling element 34 is also simply insertable into the readily accessible insertion opening 62 in the receptacle 64, and the receiving body 32 is also accessible such that the fixing bolt 88 can be pushed through the apertures 84 and 86, and 92 and 94, in a readily accessible manner.

As illustrated in FIG. 2 in connection with the first exemplary embodiment, the holding unit 30 comprises a carrier holder 28 that extends from the transverse carrier 22 in the direction of the road surface 54 and is fixedly, for example by a weld connection, connected to the transverse carrier 22 and moreover fixedly, for example by a weld connection, connected to the receiving body 32 of the carrier element 40.

For the purpose of improving security during operation of a coupling device of this kind, as illustrated in FIGS. 3 and 5 there is arranged for example on the transverse wall 79 of the receiving body 32 that faces away from the road surface 54 a sensor 112, which determines for example by way of an opening 114 in the transverse wall 79 the presence of the insertion portion 36 in the receptacle 64, in order to identify whether the insertion portion 36 is inserted into the receptacle 64 or not.

For example, the sensor 112 is a magnetic field sensor which on the one hand itself generates a magnetic field 116 that is propagated through the opening in the direction of the receptacle 64 and undergoes a deformation as a result of the inserted insertion portion 36, which is made for example from steel or another material that screens magnetic fields, wherein the sensor 112 then detects the deformation using a magnetic field detector 118 and can hence, as a result of the absence of deformation of the magnetic field 116 or the deformation of the magnetic field 116 by the insertion portion 36, identify whether the insertion portion 36 is present in the receptacle 64.

This provides the possibility of detecting whether the insertion portion is present in the receptacle 64 by way of the sensor 112 and a presence signal PS or non-presence signal NPS generated thereby.

However, since the presence of the insertion portion 36 in the receptacle 64 does not by itself allow the conclusion to be drawn that the insertion portion 36 is securely positioned in the receptacle 64, in addition there is arranged for example on one of the side walls 75 or 77 a sensor 122 which is able to detect the presence of the fixing bolt 88 when this passes through the apertures 84 and 86 in the receiving body 32.

The sensor 122 also likewise generates for example a magnetic field 126 that is propagated in the direction of the fixing bolt 88 and undergoes a deformation as a result of the fixing bolt 88, wherein the deformation is then detected by a magnetic field detector 128, with the result that the sensor 122 generates a blocking position signal BS or a non-blocking position signal NBS.

For the purpose of fixing the sensor 122, there is integrally formed for example on one of the side walls 75 or 77, for example on the side wall 77, a flange 132 that has an aperture 134 through which the magnetic field 126 can be propagated in the direction of the fixing bolt 88 in order to detect the fixing bolt 88, wherein in this case the sensor is arranged on a side of the flange 132 facing away from the fixing bolt 88.

In this arrangement, the flange 132 lies directly next to the respective aperture, in this case the aperture 86 in the side wall 77, in order to be able to detect directly the fixing bolt 88 projecting out of the aperture 86, and the opening 134 in the flange 132 faces the fixing bolt when this projects out of the aperture 86.

As an alternative to the sensors 112 and 122 taking the form of magnetic field sensors, however, it is also possible for the sensors 112 and 122 to take the form of ultrasound sensors.

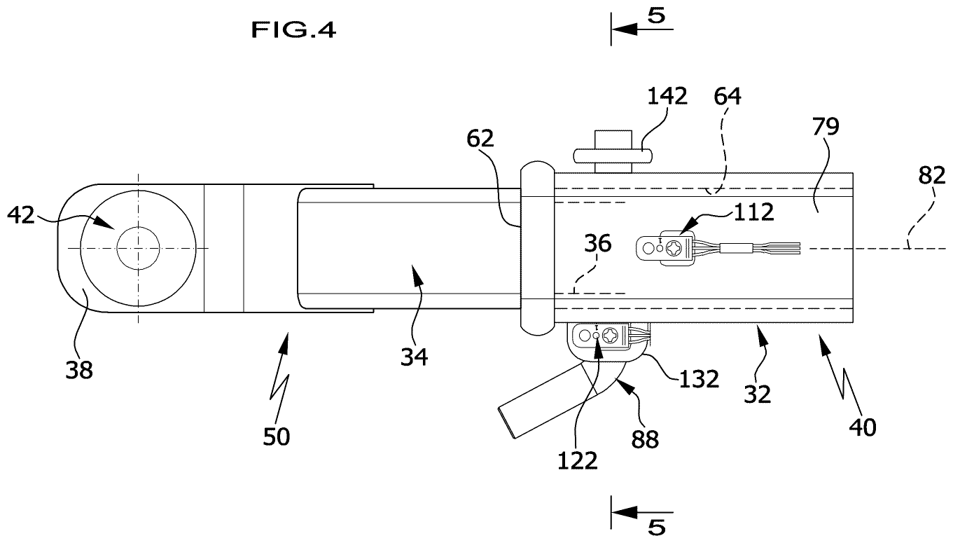

Furthermore, as illustrated in FIGS. 4 and 5, the fixing bolt 88 is also secured by a securing element 142 which engages for example in a peripheral groove 144 in the end region 146 projecting beyond the receiving body 32, wherein the securing element 142 may for example take the form of a cotter.

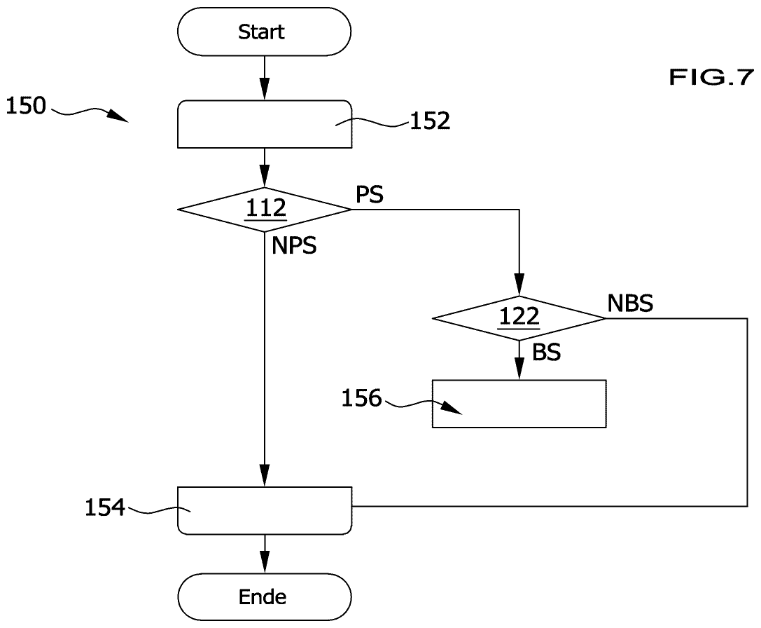

The sensors 112 and 122 are connected into a monitoring circuit 150, as for example illustrated in FIG. 7, such that, once a monitoring cycle 152 starts, at first the sensor 112 is interrogated.

If the sensor identifies that no insertion portion 36 has been inserted into the receiving body 32, then a non-presence signal NPS is generated, and a status notification 154 indicating this is activated.

If, by contrast, the sensor 112 identifies that the insertion portion 36 has been inserted into the receiving body 32, a presence signal PS is generated, and this activates the sensor 122.

If the sensor 122 establishes that the fixing bolt 88 has also been properly inserted, then a blocking signal BS is generated, and this activates the status notification 156, which indicates readiness for operation.

If, however, the sensor 122 identifies that the fixing bolt 88 is not properly present, then a non-blocking signal NBS is generated, and this activates a status notification 154 that indicates this and the absence of readiness for operation.

Thus, the monitoring circuit 150 is able to reliably establish whether the insertion portion 36 of the ball element 34 has been inserted into the receiving body 32 or not, and if this is the case a check is made as to whether the fixing bolt 88 has been properly inserted or not.

If the fixing bolt 88 is properly inserted, the status notification 154 is activated, and if this is not the case the status notification 156 is activated.

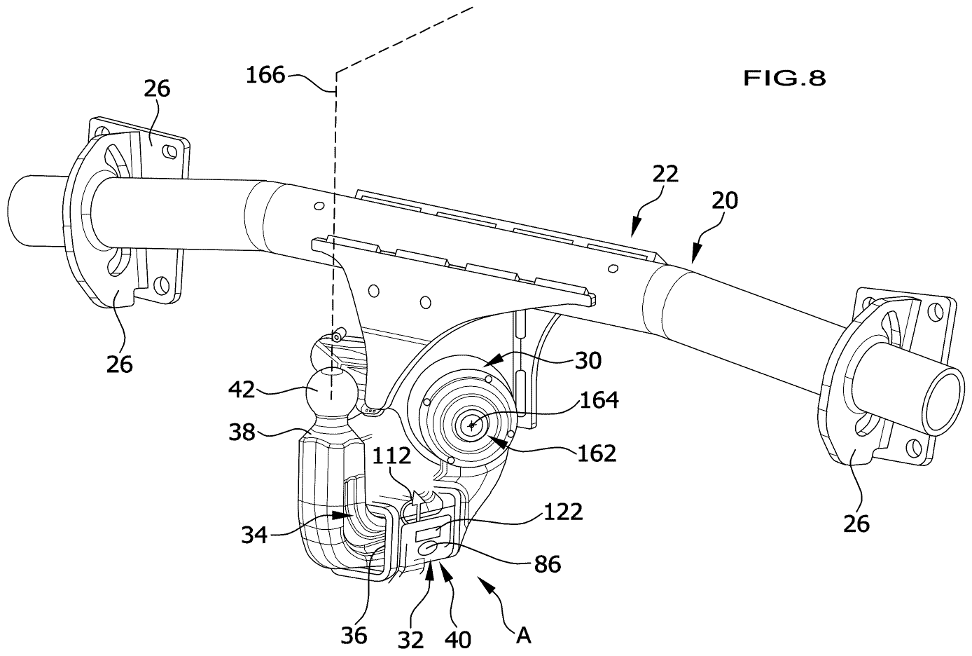

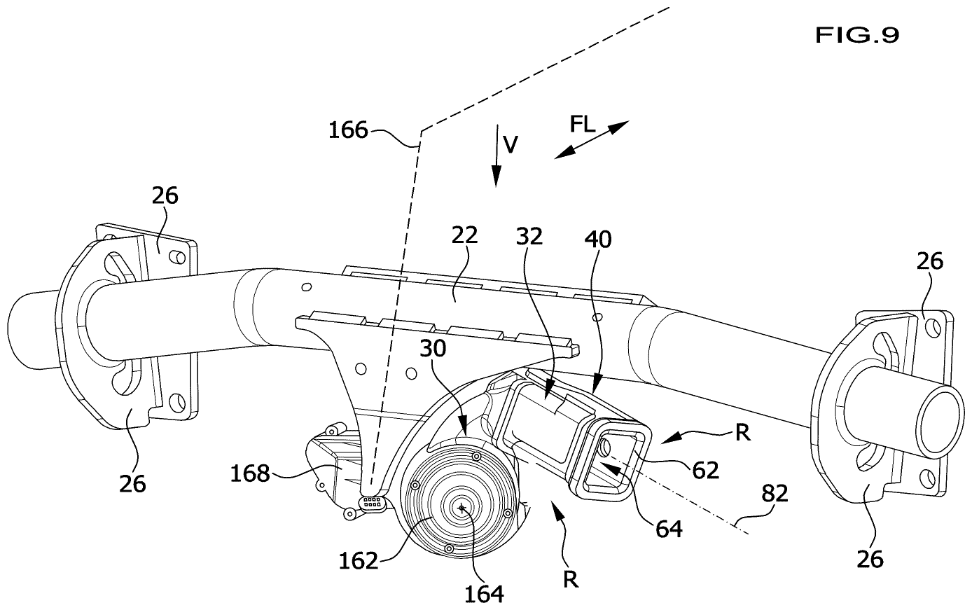

In a second exemplary embodiment, illustrated in FIG. 8, the holding unit 30 is likewise arranged on the transverse carrier 22, which as a carrier holder 28 comprises a pivotal bearing unit 162 by which the carrier element 40 and the receiving body 32 are pivotal about a pivot axis 164 that runs transversely to a longitudinal center plane 166 of the motor vehicle 10 and the coupling device 20, which extends parallel to the vehicle longitudinal direction FL and in the vertical direction V, wherein in the working position A the center axis 82 of the receptacle 64 lies in the longitudinal center plane 166, and in the rest position R illustrated in FIG. 9 it extends transversely to the longitudinal center plane 166 and approximately parallel to the transverse carrier 22.

In this case too, provided on the receiving body 32 are the sensors 112 and 122, in order to detect the presence of the insertion body 36 in the receiving body 32 and the presence of the fixing bolt 88 for fixing the insertion portion 36 in the receptacle 64.

Moreover, the pivotal bearing unit 162 is provided with an electric drive 168 by which the pivotal movement of the carrier element 40 between the working position A and the rest position R is performable, including the performance of locking in these positions.

In this case, the monitoring circuit 150′ starts a monitoring cycle 152′, which first uses the sensor 112 to check whether the insertion portion 36 is present in the receptacle 64, and if there is no insertion portion 36 inserted into the receptacle 64 uses a non-presence signal NPS to clear blocking of the unlocking of the pivotal movement by a blocking unit 158, and to permit a pivotal movement.

Thus, on actuation of an electrical pivot controller 172, it is possible to start the electric drive 168 for the purpose of unlocking and performing the pivotal movement.

If, however, the sensor 112 establishes that the insertion portion 36 is present in the receiving body 32 and emits a presence signal PS, then the blocking unit 158 is not cleared, but rather the sensor 122 is interrogated, and in the event that the fixing bolt 68 is not present this sensor 122, by a non-blocking signal NBS, activates the status notification 154 that indicates the absence of readiness for operation, and in the event that the fixing bolt 88 is present it activates the status notification 156 that indicates readiness for operation, wherein the status notification 154 and the status notification 156 refer to trailer operation, the blocking unit 158 being positioned upstream of the pivot controller 172.

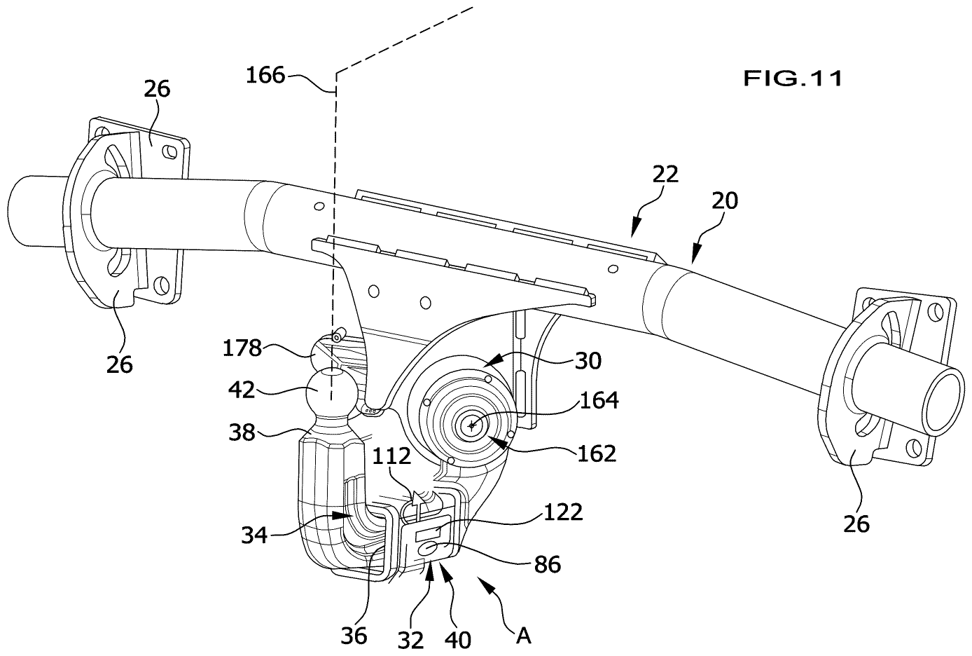

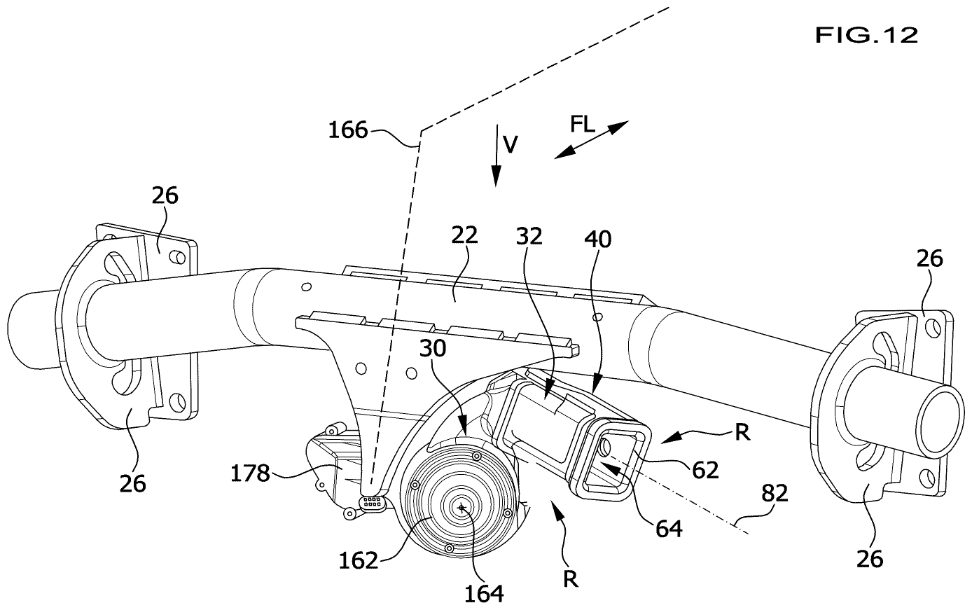

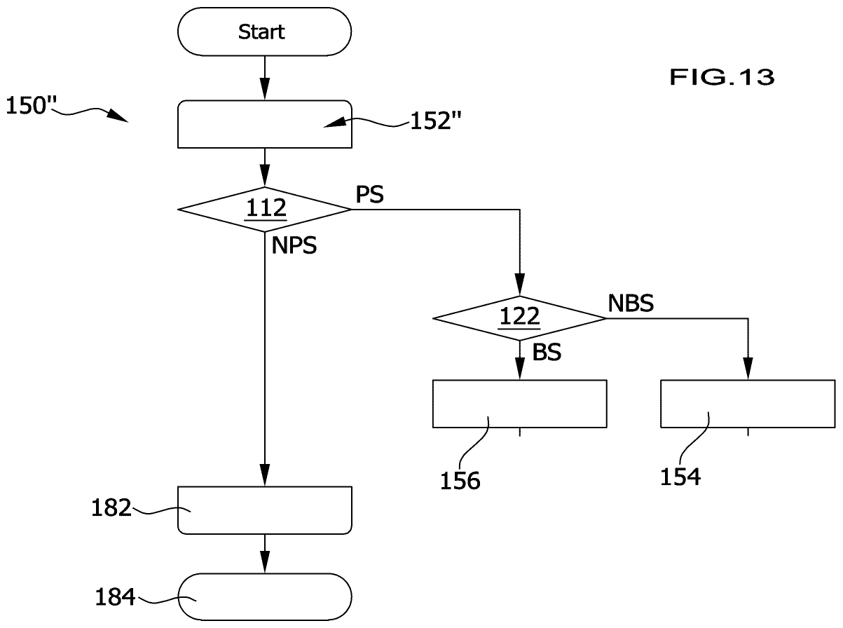

In a third exemplary embodiment, illustrated in FIGS. 11 to 13, as in the second exemplary embodiment the holding unit 30 is likewise arranged on the transverse carrier 22 and comprises, as the carrier holder 28, a pivotal bearing unit 162 by which the carrier element 40 and the receiving body 32 are pivotal about a pivot axis 164 that runs transversely to a longitudinal center plane 166 of the motor vehicle 10 and the coupling device 20, which extends parallel to the vehicle longitudinal direction FL and in the vertical direction V, wherein in the working position A the center axis 82 of the receptacle 64 lies in the longitudinal center plane 166, and in the rest position R it extends transversely to the longitudinal center plane 166 and approximately parallel to the transverse carrier 22.

In this case too, provided on the receiving body 32 are the sensors 112 and 122, in order to detect the presence of the insertion body 36 in the receiving body 32 and the presence of the fixing bolt 88 for fixing the insertion portion 36 in the receptacle 64.

Moreover, the pivotal bearing unit 162 is provided with an electrical locking device 178 for locking and unlocking the carrier element 40 in the working position A and the rest position R, wherein the pivotal movement is performed manually.

In this case, the monitoring circuit 150″ likewise starts a monitoring cycle 152″, which first uses the sensor 112 to check whether the insertion portion 36 is present in the receptacle 64, and if there is no insertion portion 36 inserted into the receptacle 64 uses a non-presence signal NPS to clear blocking of the unlocking of the pivotal movement by a blocking unit 182, and to permit a pivotal movement.

Thus, on actuation of an electrical locking controller 184 in the case of the electrical locking device 178, it is possible for unlocking and manual performance of the pivotal movement.

If, however, the sensor 112 establishes that the insertion portion 36 is present in the receiving body 32 and emits a presence signal PS, then the blocking unit 182 is not cleared, but rather the sensor 122 is interrogated, and in the event that the fixing bolt 68 is not present this sensor 122, by a non-blocking signal NBS, activates the status notification 154 that indicates the absence of readiness for operation, and in the event that the fixing bolt 88 is present it activates the status notification 156 that indicates readiness for operation, wherein the status notification 154 and the status notification 156 refer to trailer operation, the blocking unit 182 being positioned upstream of the locking controller 184.

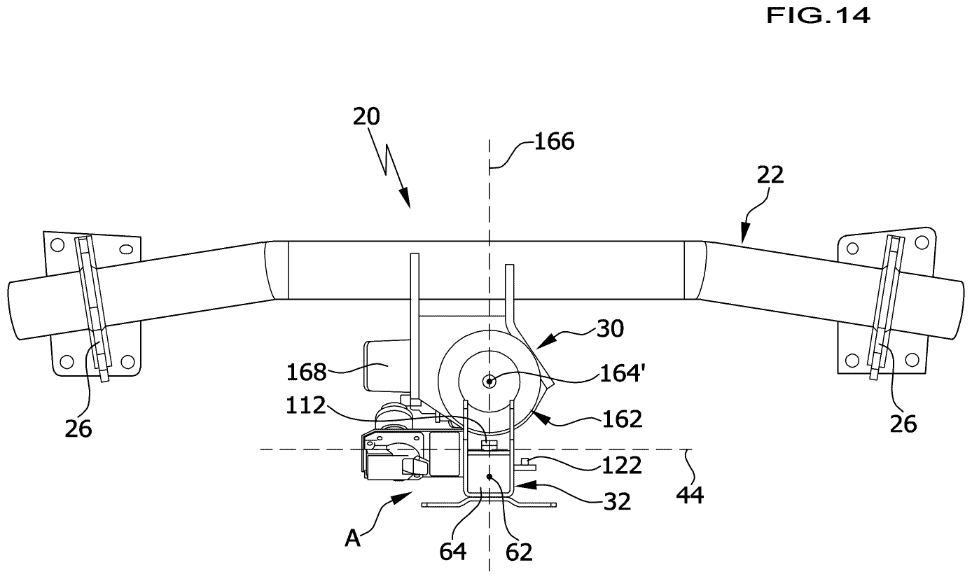

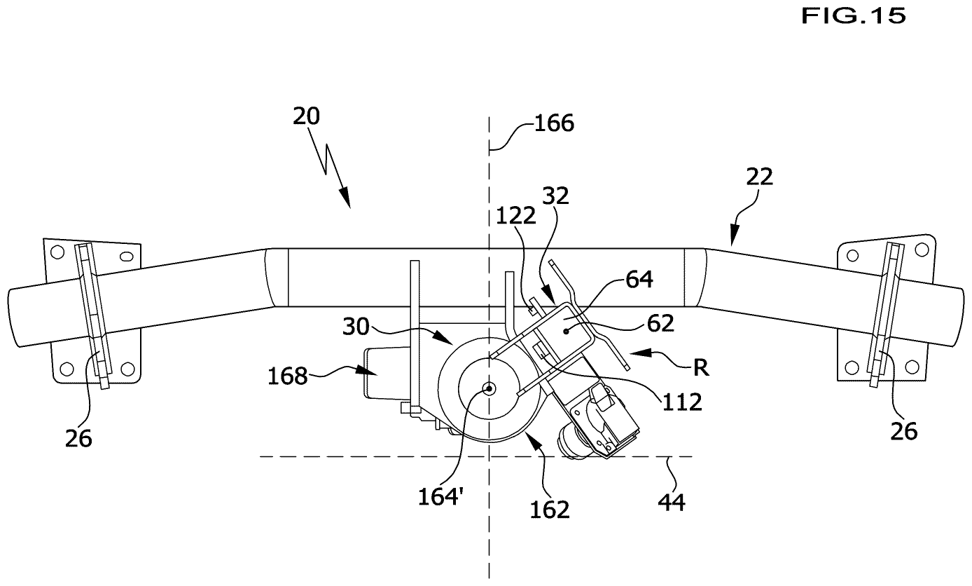

In a fourth exemplary embodiment, illustrated in FIGS. 14 and 15, the receiving body 32 is likewise pivotal between the working position A and the rest position R about a pivot axis 164′, but in this case this runs substantially parallel to or in the longitudinal center plane 166.

Further, for the purpose of pivoting, a drive 168 is likewise provided for the pivotal bearing unit 162.

In this case, the center axis 82 of the receptacle 64 then also extends substantially approximately parallel to the pivot axis 164′, with the result that as a whole the receiving body 32 always remains with the center axis 82 in an orientation parallel to the longitudinal center plane 166.

In the case of the fourth exemplary embodiment as well, the monitoring circuit 150′ takes the same form as in the second exemplary embodiment, so reference may be made to the second exemplary embodiment in its entirety.

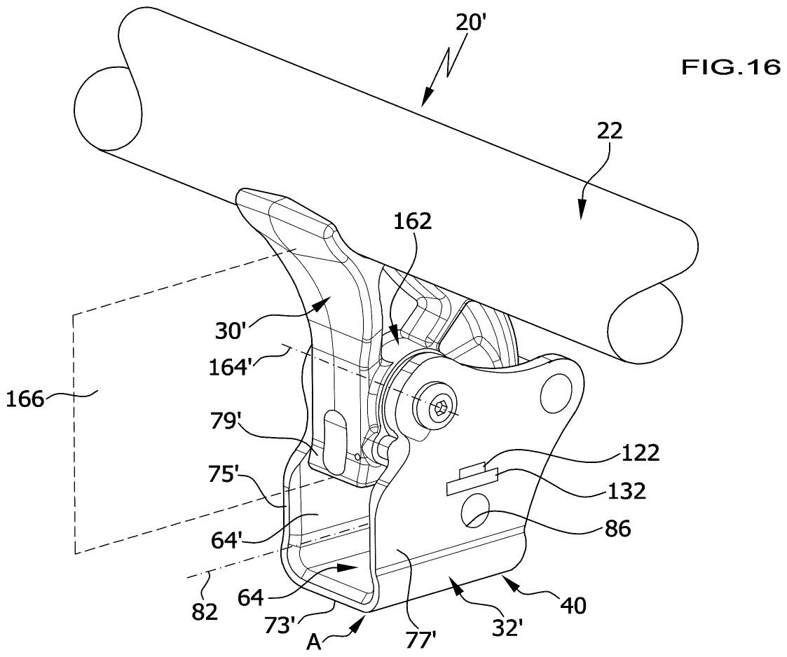

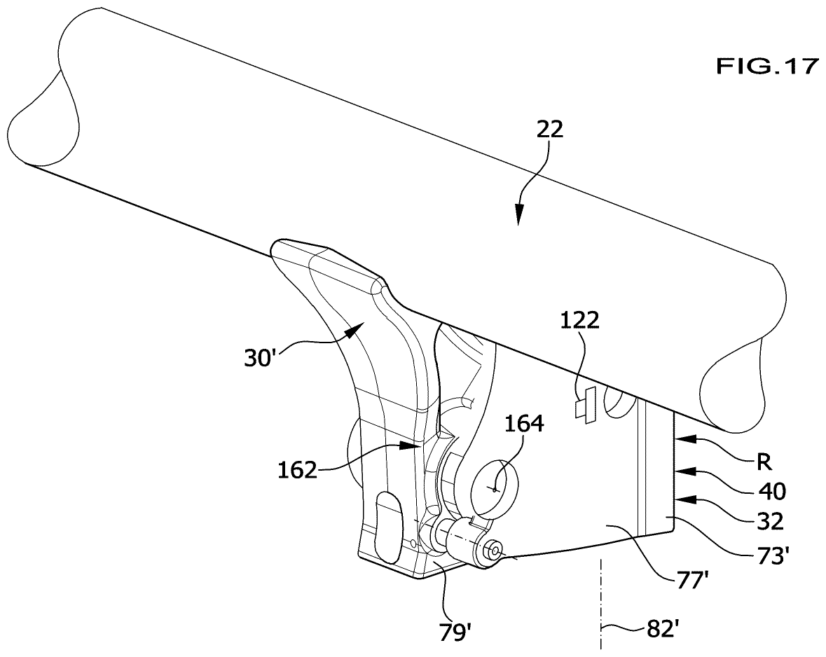

In a fifth exemplary embodiment, illustrated in FIG. 16 and FIG. 17, in the working position A the receiving body 32′ is formed by the transverse wall 73′ facing the road surface 54 and the side walls 75′ and 77′. In contrast to the exemplary embodiments above, the transverse wall 79′ facing away from the road surface 54 is fixedly connected to the holding unit 30′ and is oriented such that in the working position A it runs parallel to the transverse wall 73′, whereas the side walls 75′ and 77′ extend between the transverse wall 73′ and the transverse wall 79′.

In this case, however, the pivot axis 164′ is arranged such that it runs transversely, preferably approximately perpendicular, to the longitudinal center plane 166, such that the receiving body 32′ is pivotal from the working position A, in the direction of travel, about the pivot axis 164 and into the rest position R, in which the transverse wall 73′ and the side walls 75′ and 77′ extend transversely to the road surface 54, preferably approximately vertically, whereas the transverse wall 79′ still extends in the same direction as in the working position A.

Although this is not discernible in the fifth exemplary embodiment, the sensor 112 is arranged in the same way on the transverse wall 79′, which is fixedly connected to the holding unit 30′, as in the first, second and third exemplary embodiments.

This has the result that pivoting the receiving body 32′ from the working position A into the rest position R is not possible when the insertion portion 36 is inserted into the receptacle 64, since the transverse wall 79 blocks pivoting.

For this reason, if there is no electric drive present, the monitoring circuit 150 may take the same form as in the first exemplary embodiment.

If an electric drive is present, however, it follows that the monitoring circuit 150′ takes the same form as in the second and fourth exemplary embodiments.

1. A coupling device, comprising a carrier unit that is mountable at the rear of a vehicle body, a holding unit that is held on the carrier unit and comprises a carrier element to which a mounting element is detachably connectable, wherein the mounting element is configured either for attaching a trailer or for carrying a load carrier, wherein the holding unit is provided with a sensor for detecting the mounting element in its position held on the carrier element.

2. The coupling device as claimed in claim 1, wherein the sensor is arranged such that, in the position in which the mounting element is connected to the carrier element, it detects the presence of a predefined region of the mounting element.

3. The coupling device as claimed in claim 2, wherein the sensor detects a region of the mounting element facing away from the road surface.

4. The coupling device as claimed in claim 1, wherein the sensor is arranged in a region of the holding unit facing away from the road surface.

5. The coupling device as claimed in claim 1, wherein the sensor is arranged on the carrier element.

6. The coupling device as claimed in claim 5, wherein the sensor is arranged on a side of the carrier element facing away from the road surface.

7. The coupling device as claimed in claim 1, wherein the carrier element comprises a receiving body into which, for the purpose of making a connection with the mounting element, an insertion portion of the mounting element is insertable.

8. The coupling device as claimed in claim 1, wherein the sensor detects, as the predefined region of the mounting element, the insertion portion that is inserted into the receiving body of the carrier element.

9. The coupling device as claimed in claim 1, wherein the sensor detects the insertion portion through an opening in the carrier element.

10. The coupling device as claimed in claim 1, wherein a fixing device is provided which, in relation to the carrier element, detachably fixes the mounting element in its position held on the carrier element.

11. The coupling device as claimed in claim 10, wherein a sensor is provided for detecting the fixing device in its position in which the mounting element is fixed to the carrier element.

12. The coupling device as claimed in claim 11, wherein the fixing device comprises a fixing element, and wherein the sensor detects a blocking position of the fixing element.

13. The coupling device as claimed in claim 12, wherein the fixing element fixes the insertion portion of the mounting element in relation to the carrier element.

14. The coupling device as claimed in claim 13, wherein the fixing element is active between the insertion portion and the receiving body of the carrier element.

15. The coupling device as claimed in claim 14, wherein the fixing element takes the form of a fixing bolt which, in its blocking position, passes through the receiving body and the insertion portion and thus fixes them in relation to one another.

16. The coupling device as claimed in claim 1, wherein the sensor is a magnetic field sensor.

17. The coupling device as claimed in claim 16, wherein the sensor detects deformation of a magnetic field using a magnetic field detector.

18. The coupling device as claimed in claim 1, wherein the sensor is an ultrasound sensor.

19. The coupling device as claimed in claim 1, wherein the carrier element is pivotal in relation to the holding unit about at least one pivot axis, between a working position and a rest position, by way of a pivotal bearing unit that forms the carrier holder.

20. The coupling device as claimed in claim 19, wherein the pivot axis extends transversely to a longitudinal center plane of the coupling device.

21. The coupling device as claimed in claim 19, wherein the pivot axis extends approximately parallel to the longitudinal center plane of the coupling device.

22. The coupling device as claimed in claim 1, wherein the pivotal bearing unit is provided with an electrically actuable locking device.

23. The coupling device as claimed in claim 19, wherein the pivotal bearing unit is provided with an electric drive.

24. The coupling device as claimed in claim 18, wherein the electric drive is controllable by a pivot controller.

25. The coupling device as claimed in claim 1, wherein the coupling device is coupled to a monitoring circuit which uses the sensor to detect the presence or non-presence of the mounting element in its position connected to the carrier element, and generates a presence signal or a non-presence signal.

26. The coupling device as claimed in claim 1, wherein the monitoring circuit uses a sensor to detect the presence of a blocking position or non-blocking position of the fixing device for the mounting element, and generates a blocking position signal or a non-blocking position signal.

27. The coupling device as claimed in claim 26, wherein the monitoring circuit, in the event that the presence signal is identified and the blocking position signal is detected, activates a positive status notification for operation of the coupling device and, in the event that at least one of i) the non-presence signal and ii) a non-blocking signal is identified, activates a negative status notification.

28. The coupling device as claimed in claim 25, wherein the monitoring circuit co-operates with a blocking unit for the pivot controller of the electric drive and, if there is a presence signal, blocks the pivot controller for the electric drive from pivoting the carrier element from the working position into the rest position, and only if there is a non-presence signal clears the pivot controller for performance of the pivotal movement between the working position and the rest position.

29. The coupling device as claimed in claim 24, wherein the monitoring circuit co-operates with a blocking unit for the locking controller of the locking device and, if there is a presence signal, blocks the locking controller for the electrically actuable locking device in order to prevent unlocking of the locking device and thus pivoting of the carrier element from the working position into the rest position, and only if there is a non-presence signal clears the locking controller for clearance of the pivotal movement between the working position and the rest position.
